(19) United States
(12) Patent Application Publication
(10) Pub. No.: US 2007/0005424 A1
(43) Pub. Date: Jan. 4, 2007

(54) Computer implemented method for the purchase of an endorsed message transmission between associated individuals

(76) Inventor: Nicolas Alejandro Arauz, Brooklyn, NY (US)

Correspondence Address: Nicolas Alejandro Arauz, Apartment A, 525 Atlantic Avenue, Brooklyn, NY, 11217, US

(21) Appl. No.: 11/198,341

(22) Filed: Aug. 6, 2005

Related U.S. Application Data
(60) Provisional application No. 60/696,447, filed on Jul. 1, 2005.

(51) Int. Cl. G06Q 30/00

(52) U.S. Cl. 705/14

(57) ABSTRACT

A computer implemented business method for the purchase of a message endorsement and transmission between two associated individuals wherein a marketer establishes an endorsement agreement and a transaction with an individual subscriber in which the subscriber agrees to transmit the marketer's message to the subscriber's own peers and associates, and such transmissions are executed so that they are consistent with the marketer's intent, and verifiable to a degree that compensation can be made to the individual, as a micro-endorser of the content, for each transmission. Once the agreement has been made, the endorser assigns the marketer's message to be transmitted as content to other individuals who attempt to contact the endorser through a communication network. The transmission is verified and the endorsing individual is compensated.

### CROSS REFERENCE TO RELATED APPLICATIONS

Related to Provisional Patent Application U.S. 60/696,447 Dated Jul. 1, 2005, Titled Computer implemented method for the purchase of a message transmission between associated individuals

### STATEMENT REGARDING FEDERALLY SPONSORED RESEARCH OR DEVELOPMENT

Not Applicable

### BACKGROUND OF THE INVENTION

The present invention relates to a computer implemented business method for the purchase of an endorsed message transmission between associated individuals.

Marketing methods are used for a variety of purposes, such as commercial advertising, political advertising, cause and appeal marketing, or simply for the purpose of spreading non-commercial content. Traditionally, marketing campaigns are implemented by placing the marketing content adjacent to non-marketing content, such as the placement of a television advertisement or a magazine advertisement. For a campaign to be effective marketers rely on the popularity of the complimentary non-marketing content; therefore, the cost of different placements varies depending on the size of the audience for the non-marketing content. For instance, the cost of advertising during popular television programs is often higher than the cost of advertising on unpopular programs. In addition, qualities of the audience are also taken into consideration. For instance, the cost of placing an advertisement during a popular television program is likely to be further inflated if the audience can be shown to have a high level of expendable income. Marketing methods such as these have some inherent disadvantages. First, the cost of such marketing methods are high, since the revenue generated by the advertisements is relied upon for the development of the complimentary non-marketing content. In addition, the public has been shown to perceive these methods as intrusive to the non-marketing content, and so means have been devised to help consumers exclude marketers' content from broadcast media such as Television and Radio, such as commercial-free “Premium” Television Stations, Digital Video Recorders (“Tivo”), and Satellite Radio.

Another method of marketing, direct marketing relies on smaller, more deliberately targeted messages, using either direct mail, the telephone (telemarketing), direct email, or the variety of direct marketing methods on the internet (e.g., banner advertising, pop-up advertising, search engine advertising). These methods were devised to allow a broader range of marketers to reach specific individuals who could be identified through publicly or privately disclosed demographic or psychographic data generally known about the individuals (e.g. mailing address, telephone number, age, shopping habits, web browsing habits, etc.). These methods also have several disadvantages: First, the sheer volume of competing marketing messages that exist in these mediums make it difficult for a single marketer's message to be acknowledged; Second, these mediums are also usually perceived as intrusive to the person receiving the advertisement; Third, because of this perception, direct marketing methods such as telemarketing and direct email are being deliberately blocked by state and federal legislation.

Considering these issues, marketers have focused on finding methods and mediums to make their messages more trusted, more likely to be heard, and more relevant to the receiver (the person who ultimately receives the marketer's message). One such way is to have their offering endorsed by trustworthy or influential individuals, and to encourage these individuals to communicate with others about the benefits of the marketer's products and services. A common and long-standing manifestation of this concept is celebrity endorsement, where a marketer will pay a well-known individual to endorse a specific product, and to either record the endorsement explicitly or to embed the endorsement in media other ways (e.g., product placement in a movie or logo placement on sporting uniforms). Marketers may then use mass media to broadcast or distribute the endorsement to the public. Advertising in this manner is commonplace, but is impractical for marketers with limited resources, who are unable to pay the normal fees associated with both the celebrity endorser and the mass media. Furthermore, it is commonly recognized that a significant portion of the expense of celebrity endorsement and the associated distribution method is wasted, due to the fact that not all such endorsements are acknowledged by the audience or subscriber base of the medium (for the reasons listed above), and normally only a portion of the audience that acknowledges the endorsement considers the endorser to be a reliable and trusted endorser.

Another method is sometimes known as peer-to-peer marketing (or experience marketing or viral marketing), where the marketer sponsors and/or creates a novel experience for a targeted first-tier audience, and relies on the novelty of the experience to trigger a chain reaction in which the first-tier audience is compelled to tell their friends and other associates about the experience, and to encourage those friends and associates to continue to tell others. Experience marketing is more broadly affordable than celebrity endorsement, since the scale of the experience may range from a very small experience (e.g., a street performance, poster, graffiti, or the speaking of a brand name in an exclusive venue), to a larger experience (e.g. experiences within retail stores, sporting event sponsorship, films, entertainment events). Peer-to-peer marketing is also considered to have some advantages over conventional advertising methods, because the marketer is establishing a relationship with an individual, who, in reaction to a positive experience provided by the marketer, is compelled to work on behalf of the marketer to endorse the marketer's offering directly to a “second tier”: the individual's friends and associates. When successful, this method is recognized to have two advantages over conventional advertising: First, each one of the first-tier audience may be compelled to tell several other people (a second tier audience), who in turn may tell others (a third tier, and so on), and so the marketer can reach an extended audience with a single initiative or campaign; Second, the pre-existing relationship that the first-tier individuals have with the second tier individuals give the individuals a degree of credibility and trust, which benefits the marketer. However, in common practice, peer-to-peer marketing has a major disadvantage: the marketer has no agreement with the individual endorser, and therefore has very little control over what actual message is transmitted by the individual, or means by which to verify if any positive message was transmitted about the experience.

Another method, called Attention Brokerage, is described in U.S. Pat. No. 5,794,210 (Goldhaber, et al.). The Goldhaber invention describes a marketing method of “Attention Brokerage” and “Orthogonal Sponsorship”, in which the receiver of the advertisement is compensated for their attention to, and interaction with, advertising content broadcast on the internet, and in which the compensation may include coupons or other ‘negatively priced content’ that the receiver of the advertisement can spend on purchases online. This attempts to make the marketing content directly relevant to the receiver of the marketing content by compensating the receiver for their attention. While novel in comparison to other forms of marketing discussed above, this invention has a major disadvantage in that it requires interaction between the receiver of the marketing content and the content itself, for each placement, such as actions taken (“clicks”) on behalf of the receiver with the use of a personal computer, in order to prove that the attention of the receiver was given, so that compensation can be made accordingly. The value of the receiver's time and attention is underestimated in the invention; in practice, it is difficult to compensate receivers fairly for such use of their time. Furthermore, because the non-marketing content for the Goldhaber invention is envisioned as content that the receiver has specifically requested through the internet or other means, the marketing content adjacent to this non-marketing content is more likely to be ignored or regarded as intrusive regardless of the compensation. Furthermore, there is no explicit mechanism to compel the receiver to pass on the marketer's message to a second tier audience, and no compensation to the receiver for any further endorsement, as in celebrity endorsement arrangements.

Another method is described in U.S. Pat. No. 5,438,356, (Ushiki, et al.). Ushiki describes an accounting system for multimedia communication systems, in which third-party content, such as advertising, may be embedded in transmissions between two terminals within a multimedia communications system such as a broadband telephone system. The marketer, in the Ushiki invention, sponsors individual communication links between users, thereby reducing the cost of the service to the end user, in return for marketing content to be transmitted with the same communication link. Like other methods described above, the marketing content in the Ushiki invention is transmitted during non-marketing content, namely the time that the two communication terminals are communicating. This is a major disadvantage to marketers, because once again, like the Goldhaber invention, the marketing content is competing with more relevant non-marketing content, namely the communication itself. In addition, the Ushiki invention fails to integrate a mechanism wherein the supplier of the content (the marketer) can make advance arrangement with the user of either terminal for the endorsement of the content. Therefore, the embedded content is less likely to be perceived by the receiver as trustworthy, authentic, and/or relevant to the receiver(s).

Based on the examples above, there remains a strong need among marketers for more effective methods to make their messages more trusted, authentic, more likely to be acknowledged, and more relevant to the receiver.

### BRIEF SUMMARY OF THE INVENTION

The present invention greatly improves the ability of marketers to accomplish peer-to-peer marketing campaigns by enabling a marketer to establish a micro-endorsement agreement and transaction with an individual in which the individual agrees to transmit the marketer's message to the subscriber's own peers and associates, and such transmissions are executed so that they are consistent with the marketer's intent, and verifiable to a degree that compensation can be made to the individual, as an endorser of the content, for each transmission. Once the agreement has been made, the endorser assigns the marketer's message to be played audibly (or visibly) to incoming callers who attempt to contact the endorser through a communication network (e.g., a wireless, land-line, or internet telephone network). By the nature of the transmission method, the message is more likely to be heard by the incoming caller just prior to a conversation with the endorser, creating an increased likelihood of further conversation about the marketer's offering between the endorser and the incoming caller.

The present method offers marketers several advantages over the other existing marketing methods as listed above. First, like other methods of marketing, the present invention positions the marketing message adjacent to non-marketing content; however, the relevance to the receiver of the non-marketing content in the present invention (a telephone call to a friend or an associated individual) is likely to be much higher than the mass media. Second, the message can be transmitted during latent time prior to the telephone conversation, namely during the time while the receiver of the message (the incoming caller) is waiting for the call to be connected to the endorser and for the endorser to “pick up” the phone; therefore this method requires no additional time or effort on the part of the endorser or receiver of the message in order for the message to be heard, and positions the marketer's message in latent time when the receiver is likely to be listening or otherwise paying attention, and does not interrupt or interfere with the non-marketing content. Third, like other endorsement marketing, the present invention attaches an implicit endorsement to the marketer's content; however, this method improves the value of the endorsement because the endorser is someone personally known by the receiver of the marketing message. This endorser is therefore likely to be a trusted source of non-marketing content to the receiver, and so the embedding of the marketer's message with this non-marketing content adds specific and unique value to the marketer's message. Fourth, the message itself is created by the marketer, whereby the marketer can have control over the content of the message being exchanged between the endorser and the receiver, unlike other forms of peer-to-peer marketing. Another advantage is that the transmission of the message through a communication network provides a verifiable record of each transmission, so that the compensation can be made only for complete transmissions of the message, to minimize waste associated with other marketing methods. Yet another advantage is that the transmission of the message through a communication network enables the messages to be targeted to specific geographic locations and to specific timeframes that are most directly relevant to the message content. Still another advantage of the present invention is that the endorser can individually select the messages that are transmitted, which reduces the risk to the marketer that their message will be transmitted to a disinterested receiver. Yet a further advantage is that, with the present invention, marketers have a method which grants them access to otherwise inaccessible and undefined social networks, and to individuals who are trusted endorsers of the marketer's message within these networks. Another advantage of this invention is that the cost of individual message transmissions can be very low and still provide a cumulative benefit to the endorser who is able to place multiple transmissions per day; furthermore, the transmissions being purchased individually rather than en masse, the invention provides a medium that is accessible to marketers with very limited resources. These advantages effectively qualify the present invention as a new marketing medium with a combination of characteristics that are unavailable in other mediums.

The present method also offers all participating endorsers several benefits over other marketing methods listed above. First, with the present invention, all participating endorsers have an opportunity to be compensated for their status within their own social networks. Second, the endorser has control over the choices of marketers and message content they wish to endorse, and which they choose to transmit. Third, the endorser will have an opportunity to communicate their values, tastes and preferences through the endorsement of specific content, in much the same way that a public celebrity is able to support causes, products, and other offerings through endorsement arrangements. There is no existing marketing medium that empowers and compensates individual non-celebrity endorsement in this way and on this scale, and so these advantages effectively qualify the present invention as the first such medium.

### BRIEF DESCRIPTION OF SEVERAL VIEWS OF THE DRAWINGS

The advantages of the present invention will be more clearly understood through study of the present preferred embodiment of the invention as shown on the accompanying drawings and further described below, in which:

FIG. 1 shows the general environment of the invention;

FIG. 2 shows an overview flow chart of the invention;

FIG. 3 shows an example of an arrangement of user interfaces, data storage, and logic modules which might be used for the implementation of the business method;

FIG. 4 shows an example of a MARKETER INTERFACE;

FIG. 5 shows an example of a database record for a MESSAGE DATABASE;

FIG. 6 shows an example of a NEW ENDORSER INTERFACE;

FIG. 7 shows an example of an ENDORSER MANAGEMENT INTERFACE;

FIG. 8 shows an example of a database record for an ENDORSER DATABASE

FIG. 9 shows an example of a process on an ENDORSEMENT ROUTING INTERFACE and a TRANSMISSION MONITORING INTERFACE

FIG. 10 shows an example of a process on a TRANSMISSION MONITORING INTERFACE

FIG. 11 shows an example of a database record for a TRANSACTION DATABASE;

### DETAILED DESCRIPTION OF THE INVENTION

For the purposes of presenting a clear understanding of the invention, details are described below to describe a preferred embodiment. However, the invention may be practiced without these specific details, and may also be practiced with variations in the sequence and arrangement of the elements described herein. The preferred embodiment is comprised as follows:

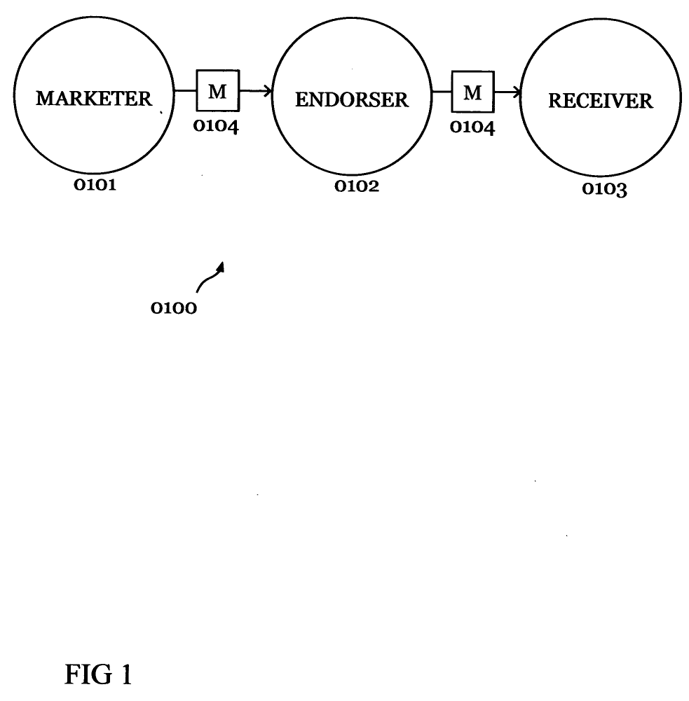

FIG. 1, is a diagram representing the general environment of the invention 0100 wherein a Marketer 0101 is interested in transmitting a message. The Marketer 0101 presents a Message Object 0104 to an Endorser 0102. Endorser 0102 receives Message Object 0104 from the marketer and agrees to transmit Message Object 0104 to one or more Receiver(s) 0103. In the general environment of the invention, Message 0104 can be content of any kind. For the preferred embodiment of the invention, Message Object has at least one characteristic that is audible, and is a digital file in a common format (e.g., .mp3, .wav, etc.)

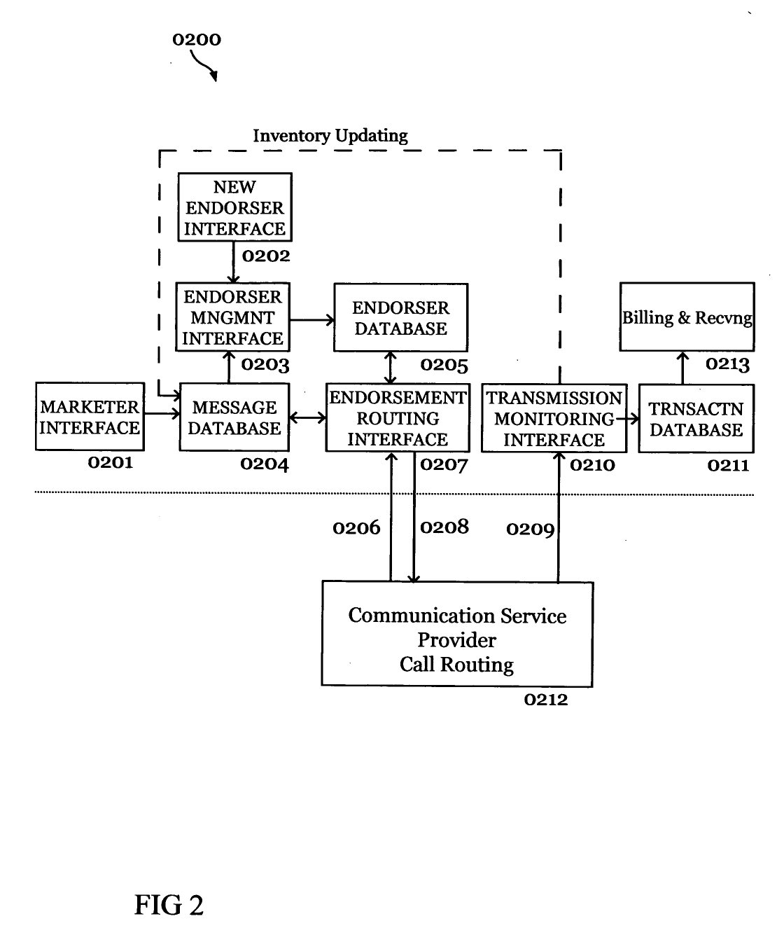

FIG. 2 is a diagram 0200 that describes an arrangement of interface means and data storage means that accommodate the invention. The method is initiated by the marketer 0101 through the Marketer Interface 0201, which supplies and modifies information on Message Database 0204; a New Endorser Interface 0202 connected to an Endorser Management Interface 0203, which supplies and modifies information on the Endorser Database 0205; A Message Database 0204 which receives and stores information from the Marketer Interface 0201, and provides information to the Endorser Management Interface 0203 and the Endorsement Routing Interface 0207; an Endorser Database 0205 which receives, stores, and updates information as directed by the Endorser Management Interface; an Endorsement Routing interface which receives Content Requests 0206 from Communication Service Provider Call Routing 0212, evaluates Content Requests 0206, extracts information from Message Database 0204, modifies information on Message Database 0204, and provides Transmission Commands 0208 to Communication Service Provider Call Routing 0212; A Transmission Monitoring Interface 0210 which receives Transmission Attempt Records 0209, evaluates these records, and supplies and modifies information on the Transaction Database 0211 and the Message Database 0204; and a Transaction Database 0211 which stores transmission records and supplies information to a conventional Billing and Receiving Module 0213.

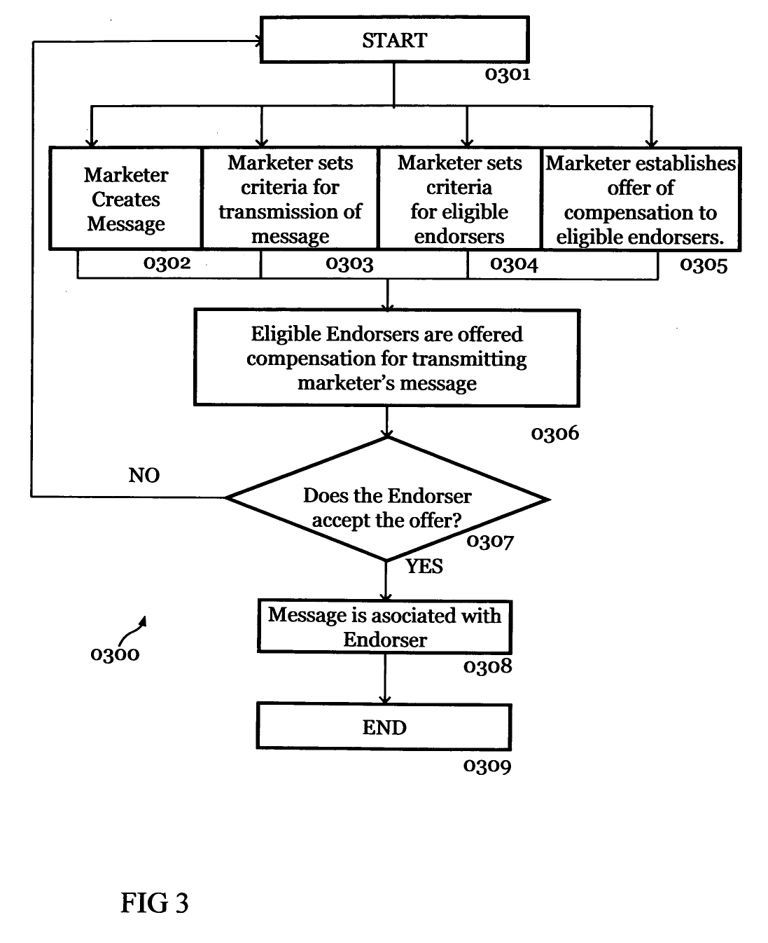

FIG. 3 is a block diagram 0300 that describes a process for the matching of a message supplied by Marketer 0101 with Endorser 0102. In this embodiment, Marketer 0101 creates a message in step 0302; Marketer 0101 sets criteria for the transmission of the message in step 0303; Marketer 0101 sets criteria for eligible endorsers in step 0304; and Marketer 0101 establishes an offer to be made to eligible endorsers, for each instance of a transmission of the message, in step 0305. Steps 0302, 0303, 0304, and 0305 can be taken in any order;

Once marketer has completed Steps 0302, 0303, 0304, and 0305, the offer established by Marketer 0101 is presented to Endorser 0102 in step 0306. In step 0307, the Endorser 0102 is given the choice whether to accept the offer and endorse the message, or to reject the offer. If the offer is rejected, the marketer may start again with new criteria. If the offer is accepted, the message is associated with Endorser 0102 in step 0308. This association is stored in a database record associated with Endorser 0101 within the Endorser Database 0205.

This process 0300 may continue, with multitude of marketers making offers to multiple endorsers; Endorser 0102 may endorse multiple endorsement offers by choice, or may limit their endorsement to a single offer. For the purpose of this example it is assumed that Endorser 0102 has accepted an offer from Marketer 0101.

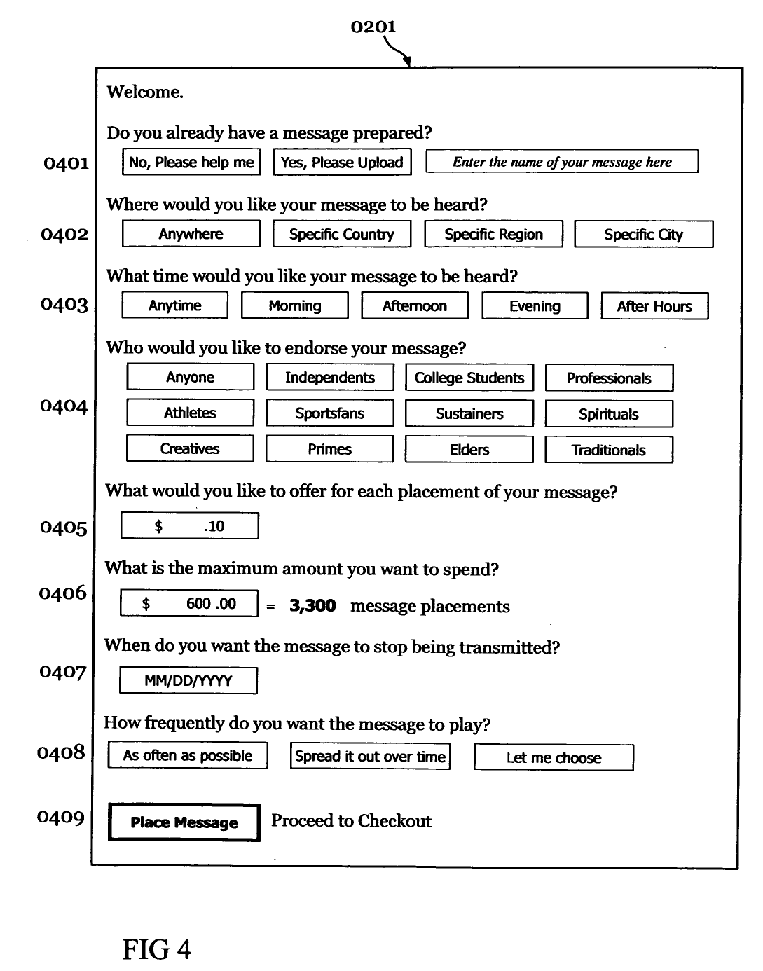

FIG. 4 illustrates an example of one version of a Marketer Interface 0201. This interface may be implemented through any means, including an internet interface, a voice interface, an interface within a communication device such as a telephone equipped with an internet browser, or any other means which can accommodate the display and input of this criteria. Step 0401 confirms that the Marketer 0101 has prepared a message, receives the message, and requests a name for the message. Step 0402 asks Marketer 0101 to select criteria for the geographic placement of the message. Marketer 0101 may select multiple locations. Step 0403 asks Marketer 0101 to select time criteria for the placement of the message. Marketer 0101 may make multiple time selections. Step 0404 asks Marketer 0101 to select one or more profiles for eligible endorsers. Marketer 0101 may make multiple selections. Step 0405 asks Marketer 0101 to make an offer of compensation, per transmission of the message, to eligible endorsers. Step 0406 asks Marketer 0101 to establish a limit of the total amount of money to be spent, including additional charges, and subsequently displays the maximum number of messages that will be placed in accordance with this limit. Step 0407 asks Marketer 0101 to select a date after which any remaining messages will expire and become ineligible for transmission. Step 0408 asks the Marketer to establish the frequency with which the message will be played. Step 0409 completes the Marketer Interface and takes the marketer to a conventional interface for a guarantee of payment.

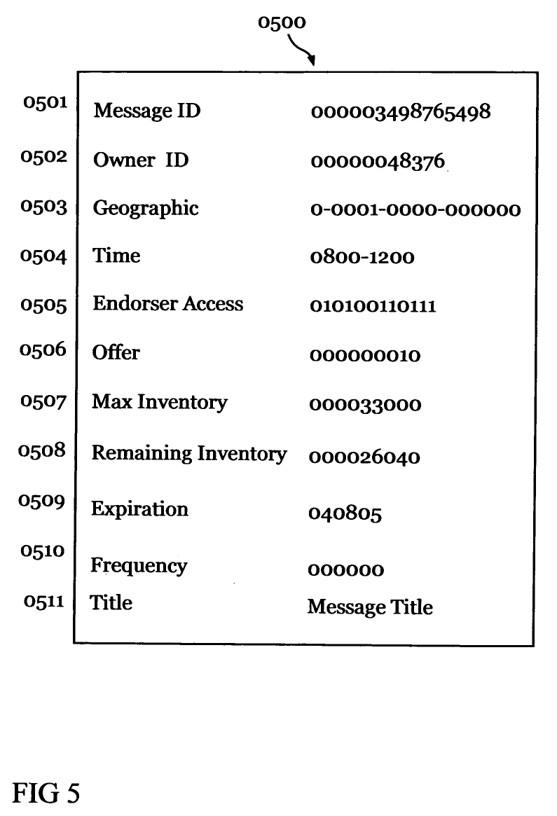

FIG. 5 is an example of a database record generated by the Marketer Interface 0201 associated with an instance of Message 0104. Field 0501 is the unique message identifier. This is automatically generated and assigned to each message. Field 0502 is the owner identifier, this identifies the owner of the Message for payment processing. For the purpose of this example, Marketer 0101 is the owner identified in field 0502. Field 0503 is the geographic transmission criteria, which identifies geographic locations to which the message may be transmitted. Field 0504 is the time transmission criteria, which defines the timeframe within which the message is eligible to be transmitted. Field 0505 is the endorser access, which specifies the profiles under which Endorsers are eligible to receive and accept the offer associated with the message. Field 0506 is the offer associated with the message. Field 0507 is the maximum inventory of the message set by the total budget, the offer, and a formula that defines additional charges applied to the cost of each transmission. Field 0508 is the remaining inventory of the message, based on the max inventory 0507 minus the total sum of all messages that have been successfully transmitted. This field is updated by the Endorsement Routing Interface 0207 and the Transmission Monitoring Interface 0210. Field 0509 is the expiration date of the message, after which the remaining message will be made ineligible for transmission. Field 0510 is the frequency of the message, which sets criteria for the number of times a message can be transmitted on a specific day relative to the Expiration Date 0509. Field 0511 is the message title associated with the message, to be displayed to Endorser 0102 in the Endorser Management Interface 0203.

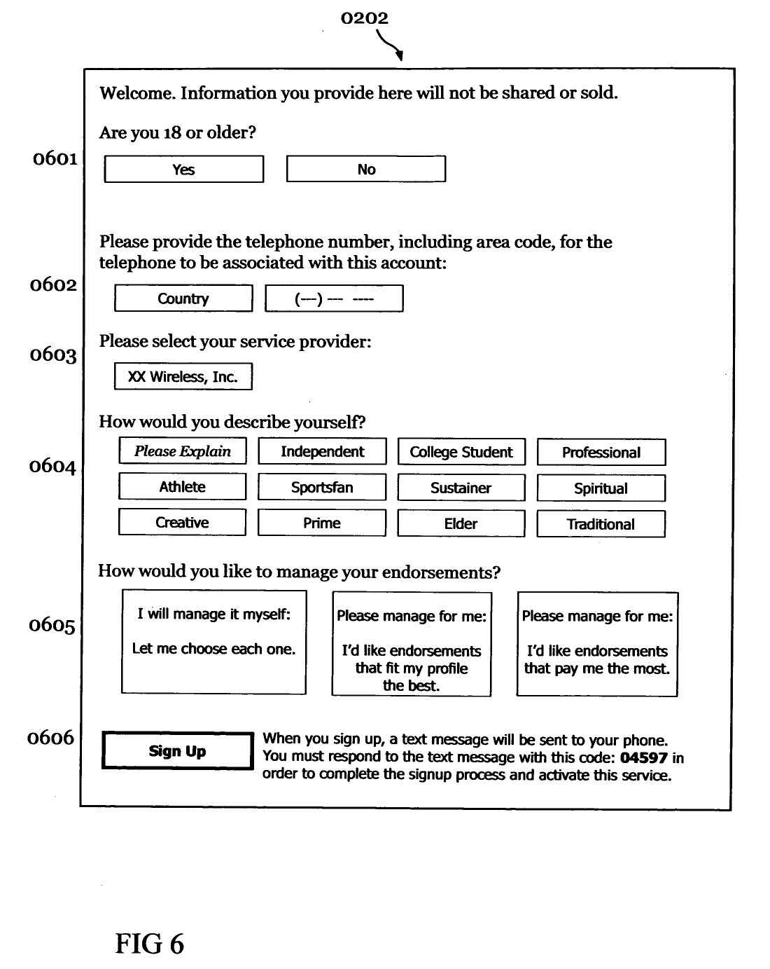

FIG. 6 illustrates an example of one version of a New Endorser Interface 0202. This interface may be implemented through any means, including an internet interface, a voice interface, an interface within a communication device such as a telephone equipped with a web browser, or any other means which can accommodate the display and input of this criteria. Step 0601 asks Endorser 0102 if their age is greater than 18 years old. Step 0602 asks Endorser 0102 to provide the country and the phone number with which their telephone account is associated. Step 0603 asks Endorser 0102 to select the communication service provider which manages the call routing for the telephone number given in step 0602. Step 0604 asks Endorser 0102 to select one or more profiles. Step 0605 asks Endorser 0102 to select a method by which endorsements will be managed: managed exclusively by Endorser 0102, managed automatically according to the profile selection, or managed automatically according to the amount of the available offers. Step 0606 confirms the choices, validates the sign-up process and moves the Endorser 0102 to the Endorsement Management Interface 0203.

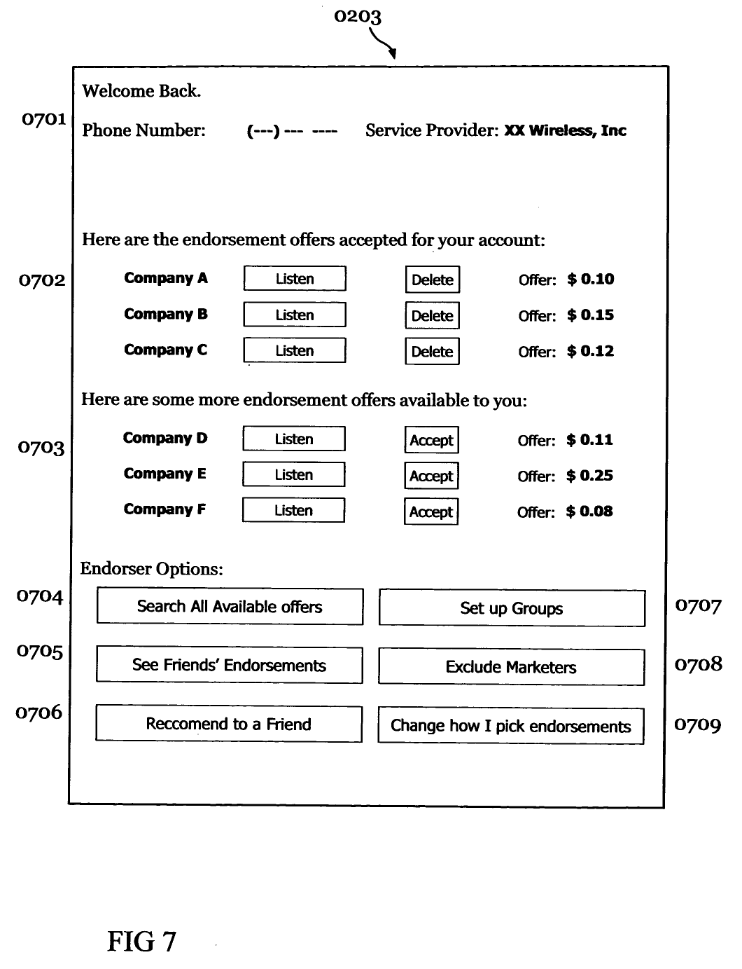

FIG. 7 illustrates an example of one version of an Endorser Management Interface 0203. This interface may be implemented through any means, including an internet interface, a voice interface, an interface within a communication device such as a telephone equipped with a web browser, or any other means which can accommodate the display and input of this criteria. Step 0701 displays the phone number and service provider associated with Endorser 0102. Step 0702 displays the accepted endorsements and the related offers associated with Endorser 0102. In step 0702, Endorser 0102 may listen to the accepted endorsements or delete the accepted endorsements. Step 0703 displays a selection of additional endorsements and the related offers available to Endorser 0102. In Step 0703, Endorser 0102 may listen to the accepted endorsements or accept these endorsements. In this example, additional steps supplemental to the invention are illustrated as follows: Step 0704 allows Endorser 0102 to search for other available offers; Step 0705 allows Endorser 0102 to view offers accepted by other endorsers who have permitted Endorser 0102 access to view such information. Step 0706 allows Endorser 0102 to recommend an endorsement to another endorser who has permitted Endorser 0102 to make such recommendations. Step 0707 allows Endorser 0102 to assign specific endorsements to specific Receivers 0103. Step 0708 allows Endorser 0102 to exclude offers made by certain instances of Marketer 0101. Step 0709 allows endorser 0102 to modify their selection made in step 0605.

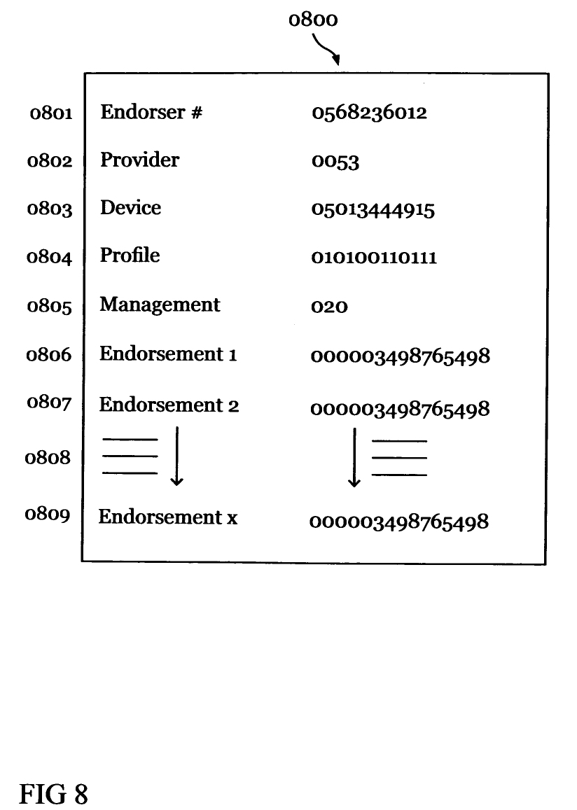

FIG. 8 illustrates a Database Record 0800 for an Endorser Database 0205. Field 0801 is a unique ID assigned to each endorser. Field 0802 is the service provider identifier, which identifies the service provider or network associated with the endorser's account. Field 0803 is the device identifier field which identifies the specific device associated with the endorser this may be represented by a telephone number, ESN, IMEI, or any other type of device identifier. Field 0804 describes the profiles selected by the endorser. Field 0805 describes the management method selected by the endorser. Field 0806 identifies a first endorsement identifier corresponding with a Message Database Record 0500 Message Identifier 0501 for a message that has been endorsed by Endorser 0102. Field 0807 identifies a second endorsement identifier for a second message endorsed by Endorser 0102. Object 0808 represents a plurality of additional fields carrying additional instances of endorsement identifiers corresponding with additional instances of message database records which have been endorsed by Endorser 0102. Field 0809 represents the endorsement identifier for the final such endorsement identifier in the database record, the value for ‘x’ in the field title could be any such number as reflects a practical and manageable number of total endorsements for a single Endorser.

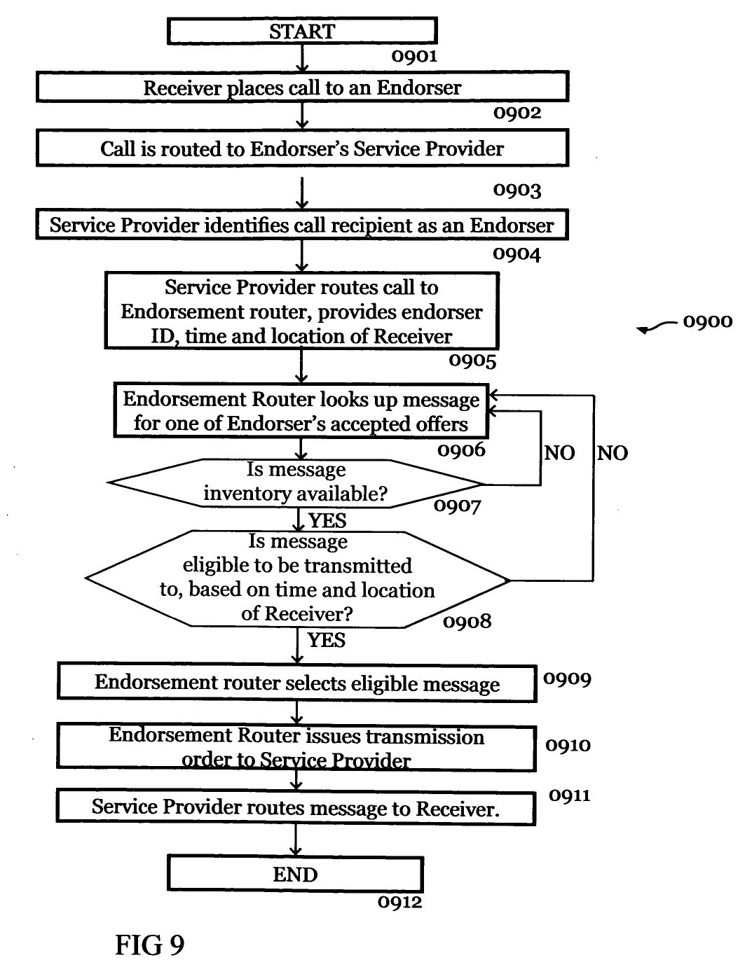

FIG. 9 represents the process flow 0900 on the Endorsement Routing Interface 0207. In step 0902 a Receiver 0103 places a telephone call to Endorser 0102. In step 0903 the call is routed to the Communication Service Provider Call Routing 0212 associated with Endorser 0102. In step 0904, Communication Service Provider Call Routing 0212 identifies the call destination as a specific device associated with an Endorser 0102. In step 0905 Communication Service Provider Call Routing 0212 initiates a process on the Endorsement Routing Interface 0207, and in FIG. 2 step 0206 provides a data packet to the Endorsement Routing Interface 0207 which includes the general location of Receiver 0103, the local time at the location of Receiver 0103, and the device identifier associated with the call destination. In step 0906, the Endorsement Routing Interface 0207 performs an operation on the Endorser database to examine the Endorsement Identifiers 0807-0809 associated with Endorser 0102, and selects a message identifier from one of the fields 0807-0809 of the Endorser Database Record 0800. For the purpose of this example, the Endorsement Router selects the Endorsement Identifier in field 0807. In step 0907 the Endorsement Routing Interface 0207 performs a lookup operation on the Message Database 0204 to examine the remaining inventory of messages in field 0508 associated with the Message Identifier 0501 corresponding to the selected Endorsement Identifier 0807. If the value of field 0508 is greater than the value of the offer in field 0506, the message is considered available for transmission and the process moves to step 0908. If the value of field 0508 is less than the value of the offer in field 0506, the message is considered unavailable for transmission and the process returns to step 0906. In step 0908, the Endorsement Routing interface performs a lookup operation on the Message Database 0204 to evaluate the Geographic Transmission Criteria field 0503 and the Time Criteria Field 0504. The value of field 0503 and field 0504 is compared to the corresponding data received in step 0206 from the Communication Service Provider Call Routing 0212. If the General Location and the timeframe of Receiver 0103 are within an acceptable range defined by corresponding fields 0503 and 0504, the process moves to step 0909. If the General Location and the timeframe of Receiver 0103 are outside of the range defined by corresponding fields 0503 and 0504, the process returns to step 9096. In step 0909, the Endorsement Routing Interface 0207 validates the message selection, and modifies the database record 0500 Field 0508 by subtracting the value of the Offer field 0506 from the value of the Remaining Inventory field 0508. In step 0910 the Endorsement Routing Interface provides the Message Identifier 0501 and the associated Message 0104 to the Communication Service Provider Call Routing 0212 with a transmission order 0208. Communication Service Provider Call Routing 0212 then routes the message to Receiver 0103. In this embodiment of the invention, Message Object 0104 is routed with the transmission order. In other embodiments of the invention, Message Object 0104 may also reside with the system associated with the Communication Service Provider Call Routing 0212; in such cases, the Endorsement Routing Interface would provide the Transmission Order 0208 and the Message Identifier 0501 only; the Message Object 0104 would be routed to Receiver 0103 from within the system associated with the Communication Service Provider Call Routing 0212 based on the directive included with the Transmission Order 0208.

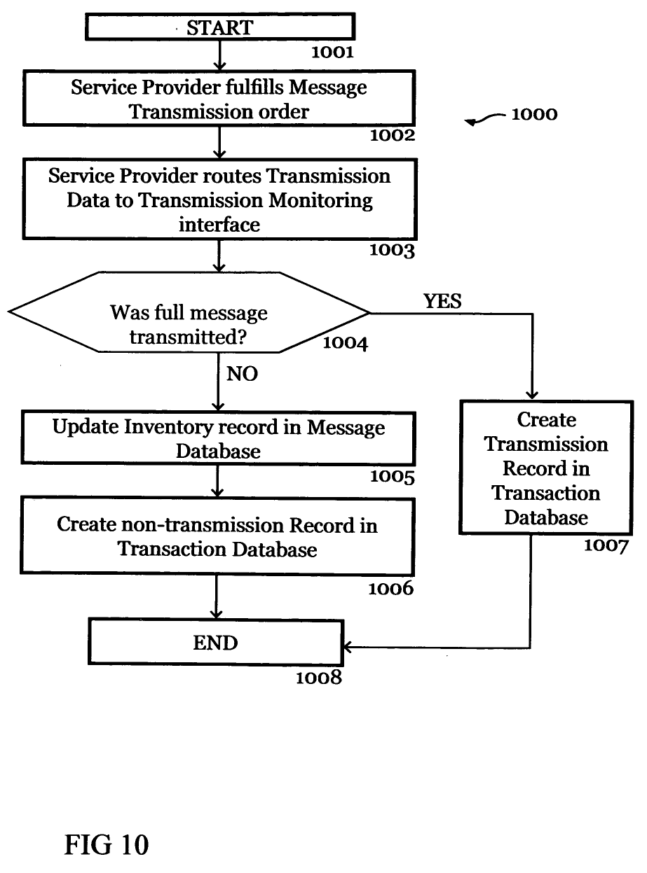

FIG. 10 represents the process flow 1000 on the Transmission Monitoring Interface 0210. In step 1002 the Communication Service Provider Call Routing 0212 fulfills the Transmission Order 0208. in Step 1003, the Communication Service Provider Call Routing 0212 provides Transmission Record Data 0209 to the Transmission monitoring interface 0210, which includes the duration of the message transmission. In step 1004, the Transmission Monitoring Interface 0210 evaluates the actual duration of the message against predefined criteria for an acceptable duration of the message. If the duration value in the Transmission Record Data 0209 satisfies the predefined criteria, the process moves to step 1007. If the duration value in the Transmission Record Data 0209 does not satisfy the predefined criteria, the process moves to Step 1005. In Step 1005, the Transmission Monitoring Interface modifies the message database record 0500 by adding the value of the offer field 0506 to the value of the Remaining Inventory field 0508. In Step 1006, the Transmission Monitoring Interface creates a record in the Transaction Database 0211 for a non-transmitted message instance. In Step 1007, the Transmission Monitoring Interface creates a record in the Transaction Database 0211 for a transmitted message instance.

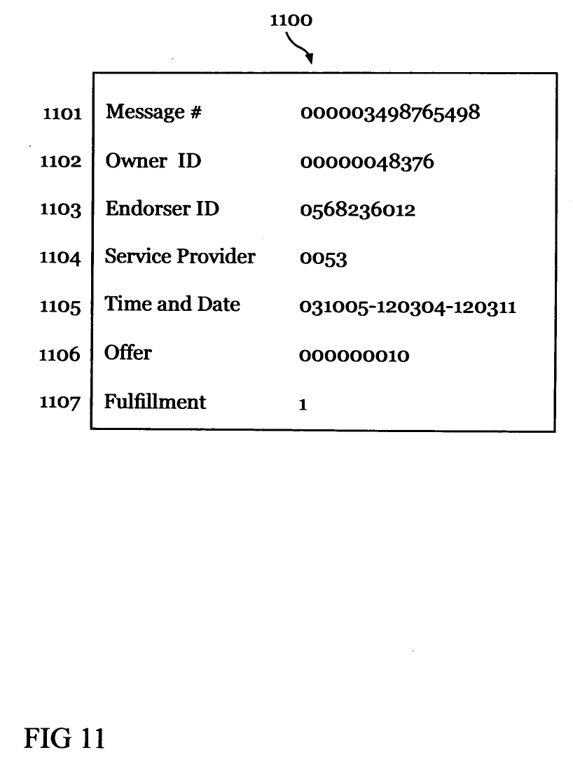

FIG. 11 represents an example of a Transaction Record 1100 in the Transaction Database 0211. Field 1101 is the message identifier associated with the Message database record 0500, field 0501, for the message associated with the transmission attempt. Field 1102 is the Owner identifier associated with the Message Database Record 0500 field 0502 for the message associated with the transmission attempt. Field 1103 is the Endorser identifier associated with the Endorser Database Record 0800 field 0801 for Endorser 0102. Field 1104 is the Service Provider identifier associated with the Endorser Database Record field 0802 for Endorser 0102. Field 1105 is the time identifier for the transmission attempt, including the date of the attempt, the start time of the transmission, and the end time of the transmission. Field 1106 is the value of the offer amount corresponding to the Message Database Record 0500 field 0506 for the message associated with the transmission attempt. Field 1107 is a value of 1 or 0 which represents the success or failure of the transmission according to the evaluation of the duration value as determined by the Transmission Monitoring Interface 0210 in step 1004.

Transaction Record 1100 is used by Billing and Receiving module 0213 to reconcile accounts billable to Marketer 0101 and to reconcile accounts payable to Endorser 0102.

This particular embodiment of the invention is one example of an implementation of the invention. Those skilled in the art will be able to devise other embodiments of the invention with modified or additional features not described in this embodiment, or may establish an alternate sequence of the steps described by this embodiment. One instance may include compensation to the Receiver 0103; another may include compensating the Communication Service Provider; another may include compensation to the Receiver 0103 within the content of the message 0104, in the form of a coupon code or an incentive; All such variations are intended to be within the scope and the spirit of the application.

I claim:

1. A computer implemented method for the purchase of a message transmission between associated individuals, which comprises the following:
(1) a marketer creating an audible embodiment of a message;
(2) said marketer identifying a set of selection criteria to establish a group of individuals who are eligible to transmit said message on behalf of said marketer;
(3) said marketer making an offer of compensation available to said group in exchange for the transmission of said message;
(4) an individual from said group agreeing to accept said offer;
(5) said message being associated with said individual's communication device and communication service provider;
(6) said marketer's message being provided to said individual's communication service provider as content to be transmitted to incoming callers who attempt to call said individual prior to the connection between said individual and said incoming caller;
(7) each such transmission being documented;
(8) said individual being compensated for such transmission.

2. A method as in claim 1 wherein step (1) further includes the marketer creating a visible embodiment of a message.

3. A method as in claim 1 wherein step (1) further includes the marketer creating an embodiment of a message that includes compensation to the incoming caller in the form of a coupon code or an incentive embedded within the content of the message.

4. A method as in claim 1 wherein step (2) further includes the marketer identifying criteria to restrict the transmission of the message to incoming callers in specific geographic locations.

5. A method as in claim 1 wherein step (2) further includes the marketer setting criteria to restrict the transmission of the message to incoming callers during specific ranges of time;

6. A method as in claim 1 wherein step (3) further includes the marketer agreeing to additional compensation for each transmission being made to one or more additional parties (e.g., the service provider, network operator, endorsement broker, or incoming caller).

7. A method as in claim 1 wherein step (4) further includes the individual allowing a third party to agree to said offers,

8. A method as in claim 7 wherein step (5) further includes the individual permitting a third party to assign said message to be transmitted through the individual's telephone account, or through service providers and/or operators of communication networks to which said individual subscribes.

9. A computer implemented method for the purchase of a message transmission between associated individuals, which comprises the following:
(1) a marketer creating a digitally or otherwise transmittable embodiment of a message;
(2) said marketer identifying a set of selection criteria to establish a group of individuals who are eligible to transmit said message on behalf of said marketer;
(3) said marketer making an offer of compensation available to said group in exchange for the transmission of said message;
(4) an individual from said group agreeing to accept said offer;
(5) said individual associating said message with a communication device and communication service provider;
(6) said message being provided to said individual's communication service provider as content to be transmitted to other individuals;
(7) each such transmission associated with said individual being documented;
(8) said individual being compensated for such transmission.
